(19) United States
(12) Patent Application Publication
(10) Pub. No.: US 2009/0045362 A1
(43) Pub. Date: Feb. 19, 2009

(54) Positive Locking Valve Control Device With Squeeze Trigger

(76) Inventors: Michael Michna, II, North Huntingdon, PA (US); John Neighoff, JR., Harmony, PA (US)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 12/104,986

(22) Filed: Apr. 17, 2008

Related U.S. Application Data
(60) Provisional application No. 60/913,040, filed on Apr. 20, 2007.

(51) Int. Cl. F16K 35/00; F16K 31/60

(52) U.S. Cl. 251/99

(57) ABSTRACT

A mechanism used for locking a valve that provides positive control of the valve lock to prevent the valve from changing position unintentionally is disclosed. The positive locking valve control device preferably includes a housing with a handle and a linkage extending therefrom. A main gear inside the housing is disposed about a shaft which is positionally fixed outside of the housing. The main gear is releasably intermeshed with a locking gear controlled by the handle. Squeezing the handle separates the gear and allows angular movement of the handle which corresponds to movement of the linkage. The linkage is connected to a valve actuator or valve stem and the position of the valve may be adjusted in this manner. Springs in the handle cause the main gear and locking gear return to a locked position when the handle is released. Accordingly, the valve cannot drift or be bumped out of position when the handle is released.

### CROSS-REFERENCE TO RELATED APPLICATION

This application claims the benefit of U.S. Provisional Patent Application Ser. No. 60/913,040, filed Apr. 20, 2007, the disclosure of which is hereby incorporated by reference.

### FIELD OF THE INVENTION

The present invention relates to valve control devices, and more particularly relates to a positive locking valve control device with a squeeze trigger that may prevent unintended movement of the valve.

### BACKGROUND INFORMATION

Top mount controls are used to open and close water valves. Such devices are particularly suited for use with water valves located on vehicles such as fire trucks in order to prevent the valve from changing position unintentionally while it is either in use or awaiting use. However, conventional top mount controls tend to slip, causing the valve position to change unintentionally.

U.S. Pat. No. 6,568,654, which is incorporated herein by reference, discloses a positive locking valve control device which includes a push-pull rod having a toothed configuration that is engaged at different positions by a spring mechanism on the valve locking device in order to hold the push-pull rod and thereby the valve securely in place. This configuration is often used to provide a side mounted control for a water valve on a fire truck. However, the push/pull nature of this control device is better suited for a side mount control than for a top mount control.

A need exists for a valve locking mechanism that provides positive control of the valve lock. A need also exist to provide a valve locking mechanism that is easily controlled from a top mount configuration.

The present invention has been developed in view of the foregoing.

### SUMMARY OF THE INVENTION

The present invention provides a mechanism used for locking a valve that provides positive control of the valve lock to prevent the valve from changing position unintentionally. The positive locking valve control device preferably includes a housing with a handle and a linkage extending therefrom. A main gear inside the housing is disposed about a shaft which is positionally fixed outside of the housing. The main gear is releasably intermeshed with a locking gear controlled by the handle. Squeezing the handle separates the gear and allows angular movement of the handle which corresponds to movement of the linkage. The linkage is connected to a valve actuator or valve stem and the position of the valve may be adjusted in this manner. Springs in the handle cause the main gear and locking gear to return to a locked position when the handle is released. Accordingly, the valve cannot drift or be bumped out of position when the handle is released.

An aspect of the present invention provides a valve locking device comprising a housing containing a main gear coupled to a shaft projecting from the housing; a linkage extending from the housing in a first direction; a first rod having a first end connected to the housing and a second end extending from the housing in a second direction; a handle assembly connected the second end of the outer rod, the handle assembly comprising a handle top and a handle bottom; a second rod connected at a first end to the handle assembly and connected at a second end to a locking gear, the second rod adjacent with the first rod and the locking gear intermeshed the main gear, whereby the angular movement of the housing relative to the shaft is restricted; wherein pressure applied to the handle assembly separates the locking gear from the main gear permitting movement of the housing relative to the shaft.

These and other aspects will become more apparent from the following description.

### BRIEF DESCRIPTION OF THE DRAWINGS

FIG. 1 is an isometric view of the left side of the valve control device according to one embodiment of the present invention.

FIG. 2 is an isometric view of the right side of the valve control device according to one embodiment of the present invention.

FIG. 3 is a right side view of the valve control device showing some of the internal components of the device according to one embodiment of the present invention.

FIG. 4 is a front view of the valve control device of FIG. 3 showing some of the internal components of the device according to one embodiment of the present invention.

FIG. 5 is a cross sectional view of the valve control of FIG. 4 along section line 5-5.

FIG. 6 is left side partial sectional view showing the interior components of the valve control device with the teeth of the main gear intermeshed with the teeth of the locking gear according to one embodiment of the present invention.

FIG. 7 is left side partial sectional view showing the interior components of the valve control device with the teeth of the locking gear separated from the teeth of the main gear according to one embodiment of the present invention.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

The present invention provides a valve control mechanism that provides positive control of the valve actuator to prevent the valve from changing position unintentionally. In certain respects, the valve control mechanism is well suited to be used as top mount water valve control on a fire truck. However, in other respects the valve control device may be used to control many different valves in numerous locations, e.g., any water or gas valve adapted to be actuated by the linkage of the valve control device.

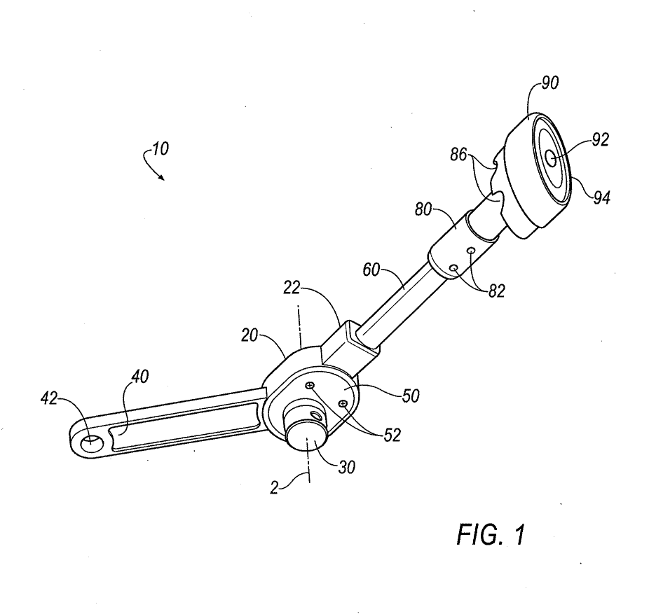

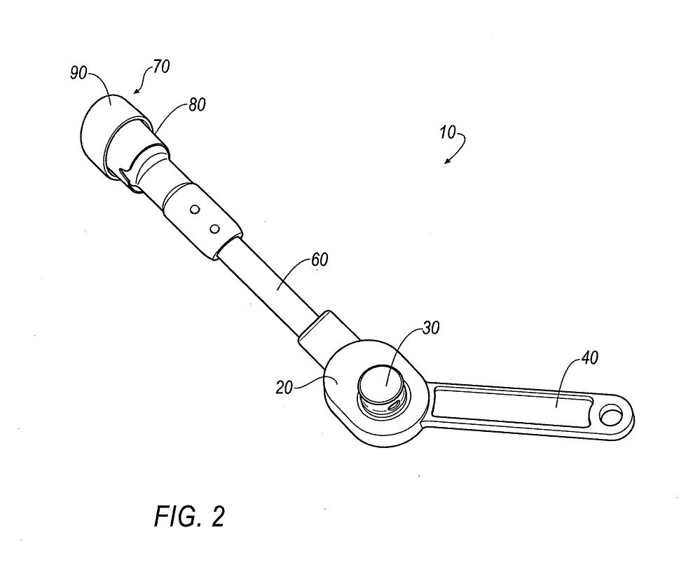

FIGS. 1 and 2 show isometric views of the left and right hand sides of a valve control device 10, respectively, according to one embodiment of the present invention. The valve control device 10 has a central housing 20 which holds main gear 30. Attached to and extending from the housing 20 is a linkage 40. As used herein, the term “linkage” refers to a mechanical linkage which is a series of rigid links connected with joints to form a closed chain, or a series of closed chains. The linkage 40 shown in the embodiments of FIGS. 1-7 described herein illustrates the first in the series of two or more rigid links. It will be appreciated by one skilled in art that the movement of the linkage at this first link can be translated into countless outputs by additional rigid links connected by joints. In one embodiment, the linkage 40 connects to a valve stem which spans from outside of a valve body (not shown) to inside the valve body or other valve part, thereby transmitting motion of the linkage which controls the internal workings of the valve, for example, movement of a gate or globe. Linkage 40 may also have an aperture 42 or other arrangement for connecting the linkage to the valve. In one embodiment, the linkage 40 connects to another member which is then connected to the valve. The housing 20 may have a cover 50 held in place by cover screws 52. The cover 50 allows access to the interior of the housing 20.

Also extending from and connected to the housing 20 is outer rod 60. It should be appreciated that the outer rod 60 and linkage 40 extend from the housing 20 in different directions. It should further be appreciated that main gear 30 is centered about a central longitudinal axis 2. Attention is drawn to the fact that outer rod 60 and linkage 40 extend not only from the housing 20 but, more particularly, extend radially from the central longitudinal axis to the main gear 30. In this manner, angular rotation of the outer rod 60 causes similar angular rotation of the linkage 40. For example, in the embodiment shown, linkage 40 and outer rod 60 are each lie in a plane generally perpendicular to the longitudinal axis 2 and arranged approximately 140° apart. This angle may be any angle capable of translating rod 60 movement into suitable movement of the linkage 40 within the valve body.

Still referring to FIGS. 1 and 2, it can be seen that outer rod 60 is connected at one end to the housing 20. A set screw 22 may be used to hold the outer rod 60 within housing 20. At its other end, the outer rod 60 is connected to the handle assembly 70. The handle assembly 70 includes a bottom handle 80 and a top handle 90. Bottom handle 80 is attached to an inner rod (not shown) by way of roll pins 82. The top handle 90 is secured to the outer rod 60 by way of a retention screw 92. The top handle 90 may also have a label area 94 recessed in its outer surface providing a convenient location to label the valve controlled by device 10 with appropriate indicia. The handle assembly 70 is configured to allow a person to grip the handle assembly 70 with one hand and squeeze the bottom handle 80 and top handle 90 so that bottom handle 80 and top handle 90 move with respect to one another. In the embodiment described herein, the bottom handle 80 is pulled into top handle 90 which releases housing 20 to move freely about the main gear 30 and its corresponding central longitudinal axis 2. As a consequence, linkage 40 also moves and adjusts the valve position. Ergonomic contours 86 may be provided on the exterior of bottom handle 80 to allow easier gripping of the handle assembly 70.

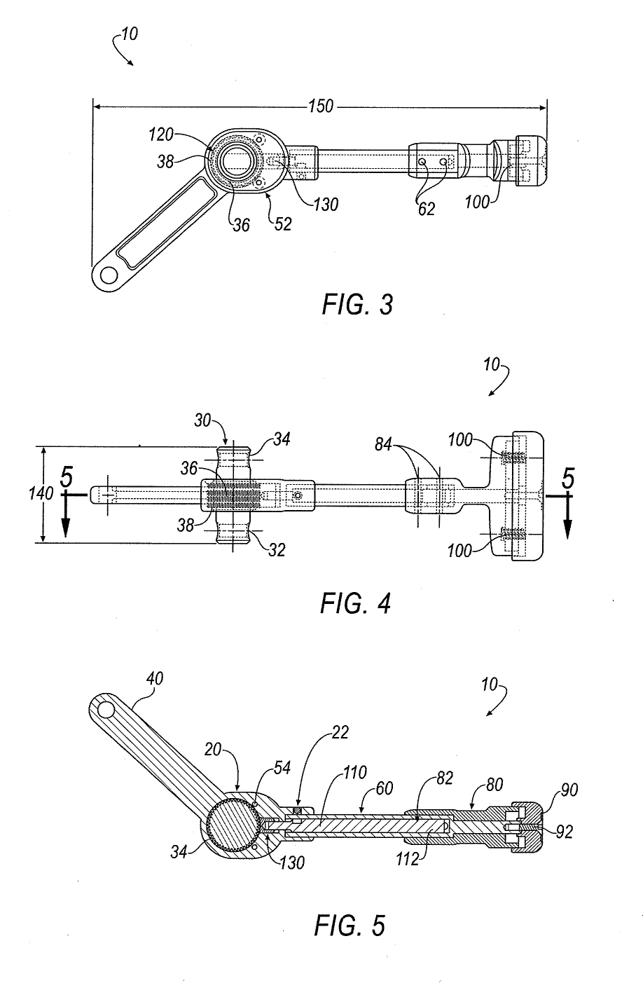

Referring now to FIGS. 3-5, the interior components of the valve controlled device 10 according to the embodiment shown in the FIGS. 1-2. The main gear 30 comprises a shaft 32 which may have holes 34 therein. The main gear 30 also has a center section 36 which is located within the housing 20. The center section 36 has teeth about its circumference. As used herein, the phrase “main gear” refers to a toothed wheel that engages another toothed mechanism. The housing 20 has cover screw holes 54 for receiving cover screws 52. The handle assembly 70 is equipped with springs 100 located between the bottom handle 80 and the top handle 90. As used herein, the term “spring” refers to a flexible elastic object used to store mechanical energy. The spring may be any suitable type, e.g., cantilevered, coiled, compression, tension or leaf. Springs 100 apply pressure which keeps bottom handle 80 and top handle 90 separated. An inner rod 110 is coaxially located within outer rod 60. Inner rod 110 is connected to the bottom handle 80 by roll pins 82. Bottom handle boars 84 align with inner handle boars 112 to define roll pin boars 86 through which the roll pins pass. It should be noted that while roll pins and other mechanical fastening means were described herein, any suitable fasteners may be used. Similarly, although springs 100 are shown, any resilient number capable of applying, constant pressure may be used. Each roll pin 82 also passes through a slot 62 in the outer rod 60. Slots allow axial movement of the roll pins within the length of the slot 62. Accordingly, movement of the bottom handle 80 is translated into movement of the inner rod 110. A locking gear 130 is affixed to the end of the inner rod 110 closest to the main gear 30. As used herein, the phrase “locking gear” refers to a toothed mechanism. Hence, locking gear 130 is also located within the housing 20.

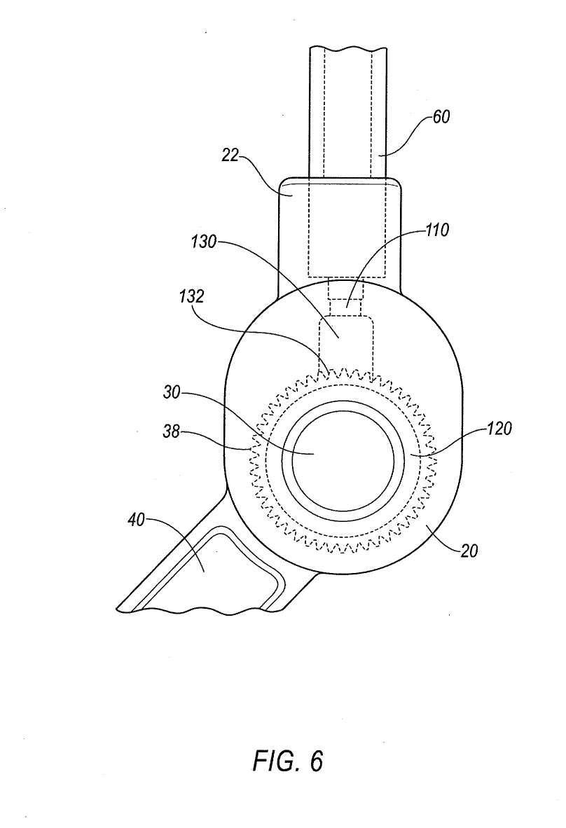

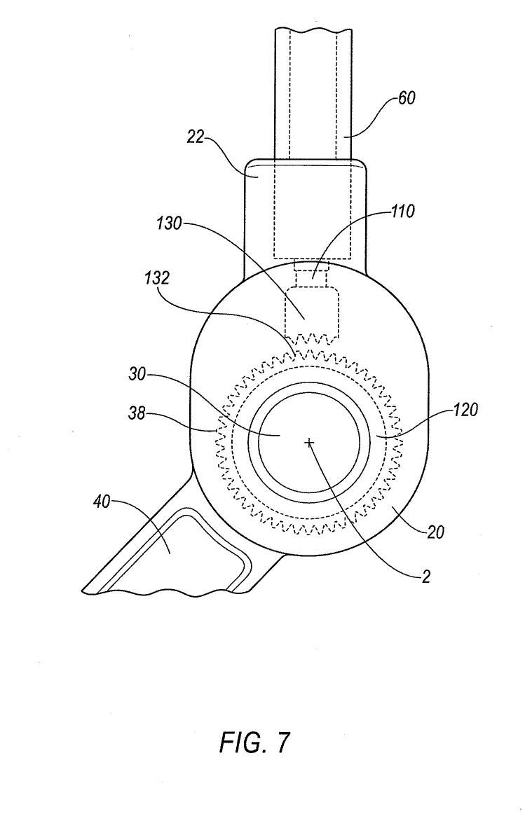

Referring now to FIGS. 6 and 7, a description of the use of valve control device 10 will be described. FIG. 6 illustrates a partial view of the interior of the valve closing device in a locked or non-rotational position. The non-rotational or locked position is the normal condition when no force is applied to the handle 70. The inner rod 110 is fully extended into the housing 20 so that the teeth 132 of the locking gear 130 intermesh with the teeth 38 of the main gear 30. It follows that due to the intermeshing of the teeth 38, 132, when the mounting holes 34 of the main gear shaft 32 which are arranged external to the housing 20 are secured onto an external frame of a mounting apparatus (not shown), the housing 20, outer rod 60 and linkage 40 will also be held in a fixed position.

Referring now to FIG. 7, the configuration of the valve control device 10 in the unlocked or rotating configuration, is shown. When bottom handle 80 is depressed into top handle 90, the bottom handle 80 acts on roll pins 82 which, in turn, act on inner rod 110. Inner rod 110 moves axially toward the handle assembly 70 which disengages locking gear 130 from main gear 30. This allows a tangential force applied to the handle assembly 70 to cause angular motion of the housing 20 along with the components attached to the housing 20 about the central longitudinal axis 2 of the main gear 30. The angular movement of the handle assembly 70 and the corresponding movement of the linkage 40 causes adjustment of the connected valve stem (not shown) and continues until the desired valve position is achieved. Once the appropriate valve setting is reached, the bottom handle is released, returning the locking gear 130 to its inner-meshed position with main gear 30. In the locked position, undesired drifting of the valve or unintended movement of the handle assembly 70 is prevented.

Whereas particular embodiments of this invention have been described above for purposes of illustration, it will be evident to those skilled in the art that numerous variations of the details of the present invention may be made without departing from the invention as defined in the appended claims.

1. A valve locking device comprising:
a housing containing a main gear coupled to a shaft projecting from the housing;
a linkage extending from the housing in a first direction;
a first rod having a first end connected to the housing and a second end extending from the housing in a second direction;
a handle assembly connected the second end of the outer rod, the handle assembly comprising a handle top and a handle bottom;
a second rod connected at a first end to the handle assembly and connected at a second end to a locking gear, the second rod adjacent with the first rod and the locking gear intermeshed the main gear, whereby the angular movement of the housing relative to the shaft is restricted;
wherein pressure applied to the handle assembly separates the locking gear from the main gear permitting movement of the housing relative to the shaft.

2. The valve locking device of claim 1, wherein the shaft projecting from the main gear is disposed about a longitudinal axis and wherein the linkage and first rod are generally oriented in a plane perpendicular to the longitudinal axis.

3. The valve locking device of claim 1, wherein the handle bottom is structured and arranged to move relative to the handle top.

4. The valve locking device of claim 3, further comprising at least one spring between the top handle and bottom handle.

5. The valve locking device of claim 4, wherein the compression of the bottom handle into the top handle separates the locking gear from the main gear.

6. The valve locking device of claim 4, wherein the second rod is coaxially located within the first rod and wherein the second rod is connected to the bottom handle.

7. The valve locking device of claim 1, wherein the linkage is connected to a valve.

8. The valve locking device of claim 1, wherein the shaft of the main gear is fastened to a rigid member to prevent rotational movement of the main gear.

9. A method of actuating a valve, comprising the steps of:
applying pressure to a handle assembly of a valve locking device, whereby a locking gear is disengaged from a main gear within a housing of a valve locking device, wherein the main gear is disposed about a longitudinal axis and a rod connects the handle to the housing;
moving the handle in a direction tangential to the longitudinal axis of the main gear, whereby said movement of the handle causes corresponding movement of a linkage connected to and extending from the housing, whereby the linkage acts upon a valve stem to open or close the valve;
stopping movement of the handle once a desired valve position is reached; and
releasing pressure from the handle of the valve locking device, thereby engaging the locking gear with the main gear in the housing.

10. The method of actuating a valve of claim 9, wherein the rod is perpendicular to the longitudinal axis of the main gear.

11. The method of actuating a valve of claim 9, wherein the handle assembly further comprises a handle top and a handle bottom.

12. The method of actuating a valve of claim 11, wherein springs are arranged between the handle top and handle bottom which reengage the locking gear with the main gear when the pressure is released from the handle.
